(19) United States
(12) Patent Application Publication
(10) Pub. No.: US 2014/0070066 A1
(43) Pub. Date: Mar. 13, 2014

(54) AJDUSTABLE HOLSTER FOR DISPLAYING COIN OF PREVIOUSLY UNKNOWN DIAMETER ON VERTICAL SURFACE

(71) Applicant: ROHTEK, LLC, Bothell, WA (US)

(72) Inventors: Oscar H. Rojas, Bothell, WA (US); Todd Klump, Kirkland, WA (US)

(73) Assignee: ROHTEK, LLC, Bothell, WA (US)

(21) Appl. No.: 14/050,251

(22) Filed: Oct. 9, 2013

Related U.S. Application Data
(63) Continuation-in-part of application No. 13/573,374, filed on Sep. 12, 2012.

(51) Int. Cl. F16M 13/02

(52) U.S. Cl. CPC F16M 13/02
USPC 248/309.4; 248/309.1

(57) ABSTRACT

Devices and methods tot supporting and displaying a coin, such as a challenge coin on a vertical surface. A device includes a backing member that can be suspended on the vertical surface, and has at least two slots. At least two prongs have bases for supporting the coin. The prongs can be inserted in the slots by an amount that adjusts for the previously unknown diameter of the coin. A letter of promotion can be framed, and the device can be attached to a front glass surface of the frame. This way, a coin can be displayed without occupying table space. Moreover, a challenge coin can be displayed together with the framed letter of promotion.

### CROSS REFERENCE TO RELATED PATENT APPLICATIONS

This patent application is a Continuation-In-Part of co-pending U.S. patent application Ser. No. 13/573,374, filed on Sep. 12, 2012, the disclosure of which is hereby incorporated by reference for all purposes, and which claimed the benefit of Provisional U.S. Patent Application No. 61/741,191, filed on Jul. 16, 2012.

### BACKGROUND

In some instances, people want to display certain coins. Some such coins include commemorative coins, collectors' coins, medallions or medals, silver dollars, casino chips, and so on.

A challenge coin is one more type of coin, which is given by some organizations to their members, and typically bears the organization's insignia or emblem. In some instances, especially in the military, a challenge coin is presented by a unit commander to a member in recognition of special achievement, or with a commendation, or given upon a promotion to a new rank. When thus given, a challenge coin serves as a reminder of the trust that has been placed on the recipient for on-going responsibility to carry out service diligently and with honor. Challenge coins are often retained with pride, long after the service has ended. There are a number of holders in the prior art for devices that will display coins, challenge coins, and other medallions. These include U.S. Pat. Nos. 2,844,248; 6,604,626; 6,896,127; 7,237,683; and 7,793,445, and US Published Patent Application Nos. 20080257756 and 20100293826.

Another holder for challenge coins in the prior art is case 100, depicted in FIG. 1. Case 100 is like a cabinet, for attaching to a vertical surface like a wall, and displaying many coins. The glass cover is openable, the coins are placed inside, and are visible through the glass cover. Case 100 is characterized as Military Challenge Coin Display Case Cabinet Holder Wall Rack w/ UV Protection, where it was found for sale in the website of www.amazon.com, prior to when this document was first filed with the USPTO.

### BRIEF SUMMARY

The present description gives instances of devices and methods for supporting and displaying a coin on a vertical surface, the use of which may help overcome problems and limitations of the prior art.

In one embodiment, a device includes a backing member that can be suspended on the vertical surface, and has at least two slots. At least two prongs have bases for supporting the coin. The prongs can be inserted in the slots by an amount that adjusts for the previously unknown diameter of the coin.

An advantage over the prior art is that a coin can be displayed without occupying table space. Moreover a letter of commendation or promotion can be framed, and the device can be attached to a front glass surface of the frame. This way, a challenge coin can be displayed together with the framed letter of commendation or promotion.

The and other features and advantages of this description will become more readily apparent from the following Detailed Description, which proceeds with reference to the drawings, in which:

### BRIEF DESCRIPTION OF THE DRAWINGS

FIG. 1 shows the image of a case for displaying multiple challenge coins in the prior art.

FIG. 2 is a sectional side view of a holster suitable for being suspended on a host vertical surface, so as to display a coin of a previously unknown diameter, according to embodiments.

FIG. 3 is a front view of the embodiment of FIG. 2, in which additionally a coin is actually supported.

FIG. 4 is a sectional side view of a holster, according to an embodiment where suspension is via an opening in a backing member of the holster.

FIG. 5A and FIG. 5B are differential drawings, showing the front views of a holster made according to embodiments, in which a smaller (FIG. 5A) and a larger (FIG. 5B) coin are being supported and displayed according to embodiments.

FIG. 6 is a side view of a prong of the holster of FIGS. 5A and 5B.

FIG. 7 is a side view of a prong of a holster, according to another embodiment in which a containing lip is further included.

FIG. 8 is a front view of a holster made according to one more embodiment, in which each prong has two bases.

FIG. 9 is a front view of a particular embodiment.

FIG. 9B is a rear view of the embodiment of FIG. 9A.

FIG. 9C is a side view of the embodiment of FIG. 9A.

FIG. 9D is a perspective view of the embodiment of FIG. 9A.

FIG. 9E is another perspective view of the embodiment of FIG. 9A.

FIG. 9F is one more perspective view of the embodiment of FIG. 9A, in which the holster appears transparent.

FIG. 10 is a flowchart for illustrating methods according to embodiments.

### DETAILED DESCRIPTION

As has been mentioned, the present description is about devices and methods for displaying coins, such as challenge coins, on a vertical surface. Embodiments are now described in more detail.

Coins, including challenge coins, are typically shaped in the form of a round disk. Medallions and challenge coins are often somewhat larger than a coin used as currency. Coins are provided in different diameters.

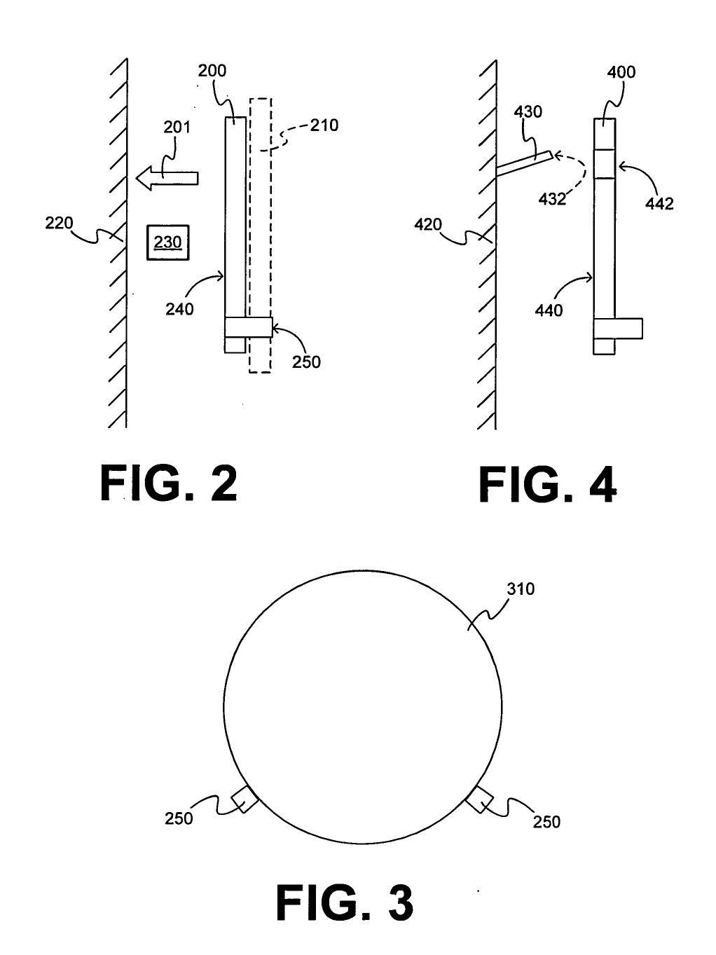

FIG. 2 is a sectional side view of a holster 200, also known as holder 200, for displaying an individual round coin 210 on a host vertical surface 220, made according to embodiments. Holster 200 is suitable for being suspended on host vertical surface 220.

In some instances, the host vertical surface is made from glass. In some of those instances, the glass is part of a frame that holds a letter of commendation or promotion. In other words, a document can be framed behind the glass, and coin 210 can be a challenge coin associated with the commendation of promotion.

Holster 200 can be made from any suitable material. A preferred material is plastic.

Holster 200 includes a backing member 240. Backing member 240 can be implemented in any number of ways, such as a wire frame, a wire mesh, and so on. In preferred embodiments, backing member 240 is in the shape of a thin plate, which is also known as a backplate. Backing member 240 can have many different shapes, and preferably it has a substantially round shape, for suggesting to the user where the coin is to be placed.

Backing member 240 is suitable for being suspended substantially vertically on surface 220. Suspending can be performed by bringing backing member 240 towards surface 220 according to arrow 201, and attaching it thereon via attaching means 230. Holster 200 in general also includes a number of prongs 250, which are described in more detail below. In this embodiment, holster 200 includes two prongs, and only one of them is shown in FIG. 2, as the other is obscured.

FIG. 3 is a front view of holster 200, in which additionally a coin 310 is actually supported. A vertical surface on which holster 200 is supported on is not shown. Since coin 310 is larger than the backplate, the only portion of the holster that is visible is two prongs 250. As will be appreciated later, the visible part is a base of each prong.

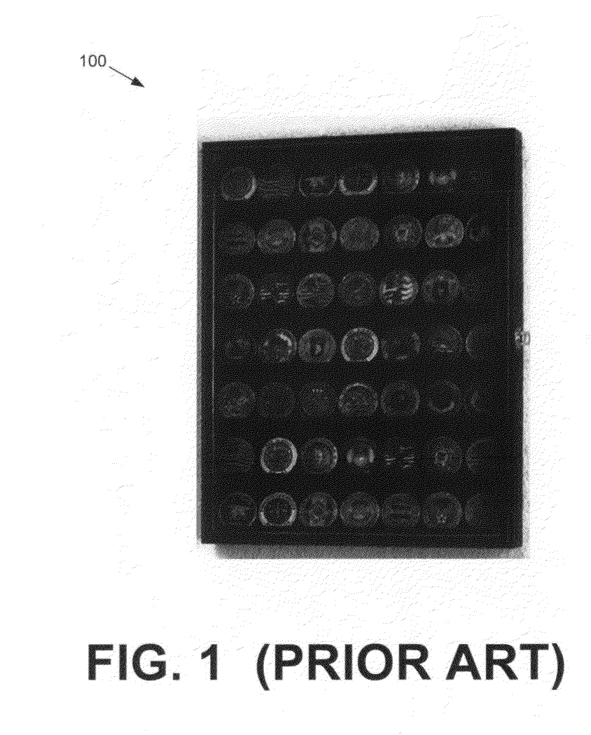

Returning to FIG. 2, suspension of holster 200 On surface 220 can be accomplished in a number of ways, by proper implementation of attaching means 230. In some embodiments, attaching means 230 includes adhesive tape or glue. The active side of adhesive tape can be exposed by peeling off a film. In some embodiments, two-sided adhesive tape can be used. Indeed, such economical means can be used because the holster of the invention can be made lightweight, since it is intended for an individual coin. This is in contradistinction of the prior art of FIG. 1, which is intended for multiple coins.

In some embodiments, attaching means 230 includes a magnet. The magnet can be attached to backing member 240 either directly, or via the above-described adhesive tape. A magnet is suitable for suspending holster 200 on a metal surface, such as a metallic cabinet. Spaces for the military and other institutions especially have many metal surfaces, for example “Vidmar” type cabinets.

In some embodiments, attaching means 230 includes one or more pins or needles. A needle can be pointing partly downward, for attaching holster 200 on the vertical surface of a cubicle wall. The one or more pins or needles can be attached to backing member 240 either directly, or via the above-described adhesive tape.

Other ways for attaching are now described.

FIG. 4 is a sectional side view of a holster 400 made according to an embodiment for suspending on a wall 420, which can be as wail 220. Holster 400 has a backing member 440, and an opening 442 through backing member 440. The attaching means can be something that goes through opening 442. In an embodiment, such attaching means can include a thumbtack. in the shown embodiment, attaching means 430 includes a protrusion 432 from wall 420, such as a nail. Holster 400 can thus be suspended on wall 420 by bringing it close and aligning, so that protrusion 432 is received through opening 442.

In general, the backing member of a holster according to embodiments includes a plurality of slots. In most embodiments, only two sinus are provided, so as to not compromise the structural integrity of the backing member. A holster according to embodiments further includes a plurality of prongs. Preferably, there are as many prongs as there slots in the backing plate. So, in the embodiment of FIG. 2, there are two prongs 250, but only ne is visible due to FIG. 2 being a side view.

Each prong may have a leg that is configured to be inserted by an adjustable depth into a respective one of the slots. Moreover, each prong may further have at least one base attached to the leg. The base may be configured to partially support the coin, when the backing member is suspended on the host vertical surface, and the prongs are inserted at least partially in their respective slots. This way, together, the bases of prongs 350 support coin 310 in FIG. 3, as the bases of prongs 250 support coin 210 in FIG. 2. The prongs support the weight of coin, but their legs do not slide out of the slots due to friction. Another example is now described.

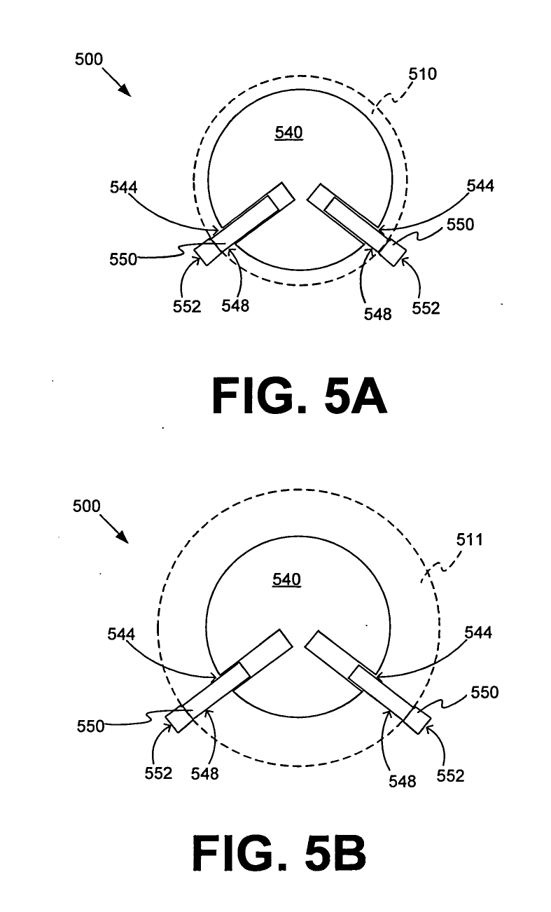

FIG. 5A and FIG. 5B are differential drawings, showing the front views of a holster 500 made according to embodiments. A smaller coin (510 in FIG. 5A) and a larger coin (511 in FIG. 5B) are being supported and displayed according to embodiments. Differential drawings operate by also examining their similarities and their differences.

The similarities of FIG. 5A and FIG. 5B are from the fact that a single holster 500 is shown. Holster 500 has a backing plate 540 with two slots 544. Holster 500 also has two prongs 550. Each prong 550 has a leg 548 configured to be inserted by an adjustable depth into one of slots 544. Each prong 550 may further have at least one base 552 attached to leg and 548.

The differences in FIG. 5A and FIG. 5B demonstrate the flexibility of embodiments of the invention. In FIG. 5A holster 500 supports a relatively smaller coin 510, and legs 548 are inserted deeply in slots 544. However, in FIG. 5B holster 500 supports a relatively larger coin 511, and legs 548 are inserted less deeply in slots 544, than in FIG 5A.

Accordingly, it will be appreciated that holster 500 can accommodate coin sizes that have a range of diameters. That is why, for some embodiments, it does not matter that the diameter of the coin is previously unknown, as long as it is within the range.

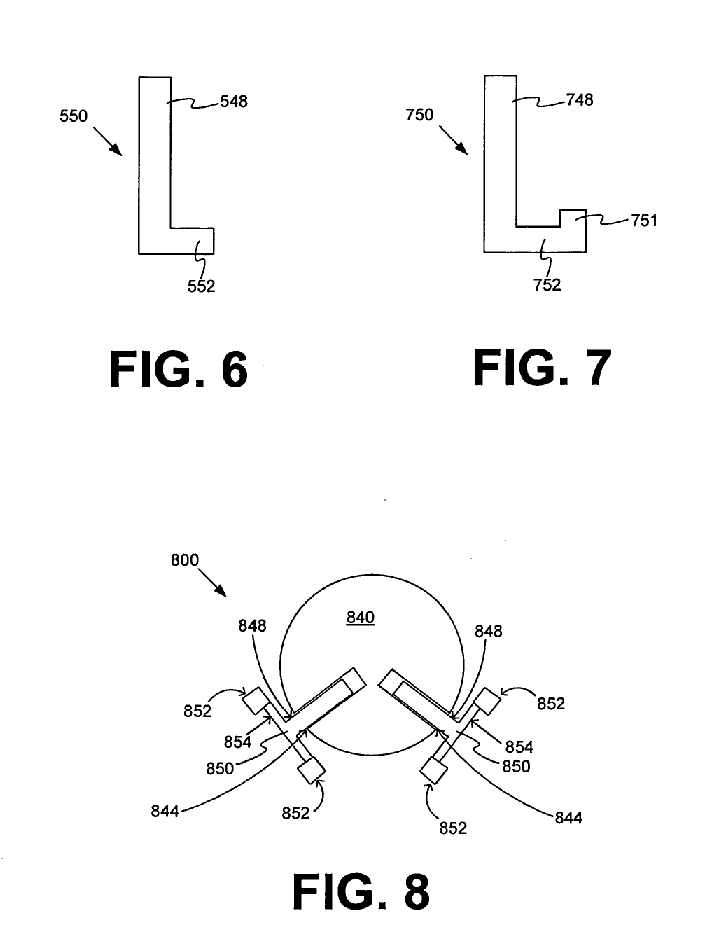

FIG. 6 is a side view of one of prongs 550 of holster 500 of FIGS. 5A and 5B, after It has been completely removed from slot 544, and is being positioned upright, in prongs 550, leg 548 is directly attached to base 552.

In some embodiments, at least one of the prongs further includes a containing lip, which is attached to the base. The lip can be configured to prevent the coin from sliding off the base, when the backing member is suspended on the host vertical surface. An example is now described.

FIG. 7 is a side view of a prong 750 of a holster according to embodiments. Prong 750 includes a leg 748 similar to leg 548, and a base 752 similar to base 552. Moreover, prong 750 includes a containing lip 751. Lip 751 is attached to base 752. Preferably, for aesthetic purposes, containing lip 751 has a substantially uniform width, along a coextensive portion of base 752.

It is preferable to have a containing lip, such as lip 751. A lip was not shown in the embodiments of FIGS. 2, 3, 4, 5A and 5B, only so as not to obscure unnecessarily the drawings.

In various embodiments, at least one of the prongs has two bases. For example FIG. 8 is a front view of a holster 800 made according to another embodiment. Holster 800 has a backing plate 840 with two slots 844. Holster 800 also has two prongs 850 for insertion in slots 844. Each prong 850 has a leg 848 and two bases 852. A bracket 854 is connected to leg 848 and bases 852, and helps keep bases 852 of each prong 850 spaced apart from each other.

There are a number of advantages to the embodiment of FIG. 8. First, bases 852 being spaced apart increases the effective range of coins diameters that can be accommodated, for the same amount of insertion of legs 848 in slots 844. Moreover, the amount of insertion of legs 848 in slots 844 can be adjusted, so that all four bases 852 contact the coin, to make the supporting more robust.

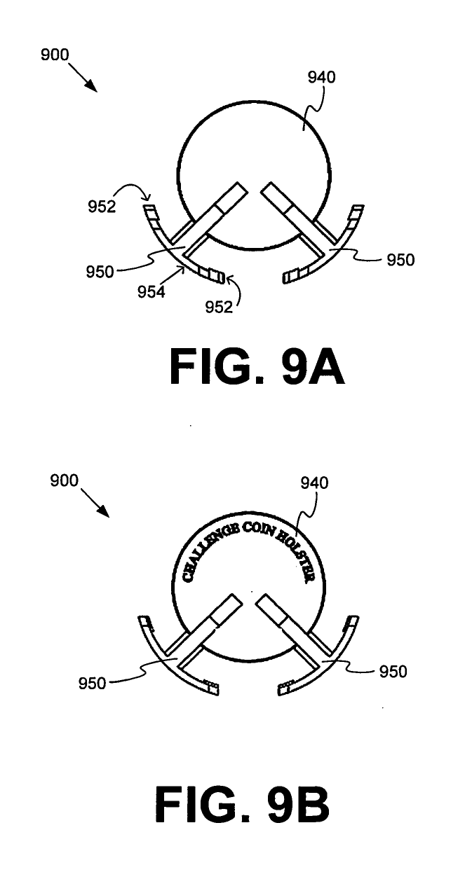

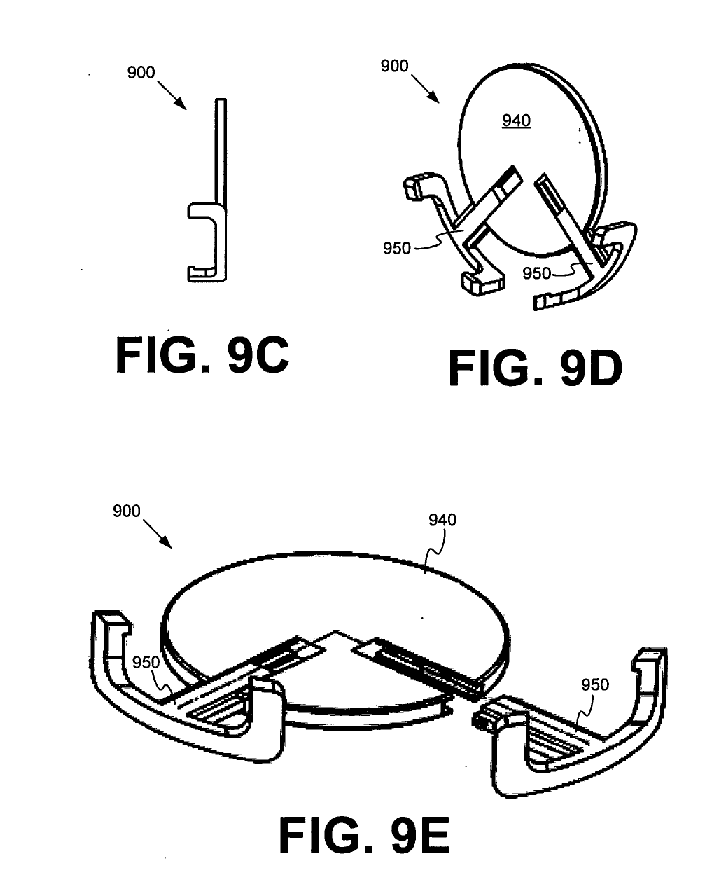

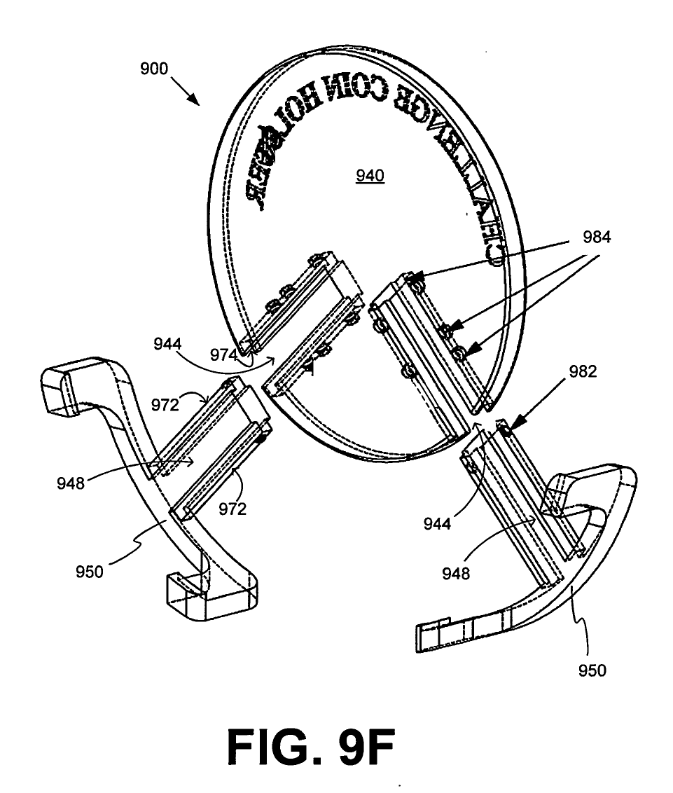

FIG. 9A is a front view of a holster 900 made according to embodiments. Holster 900 includes a backing plate 940 and two prongs 950. Each prong 950 includes two bases 952, which are held by a bracket 954. Bracket 954 is curved, in this embodiment, to further suggest to the user that bracket 954 should be substantially aligned with a perimeter of the coin, for supporting it.

FIG. 9B is a rear view of holster 900, and FIG. 9C is a side view. FIGS. 9D and 9E are perspective views of the embodiment of FIG. 9A.

FIG. 9F is one more perspective view of the embodiment of FIG. 9A, in which holster 900 appears transparent. Holster 900 may indeed be transparent if made from an optically clear material, such as acrylic and so on. Either way, FIG. 9F enables discussion of physically smaller details, whether the holster is actually transparent or not.

Backing plate of holster 900 has slots 944, and prongs 950 have legs 948. As mentioned above, prongs 950 are held by backing plate 940 due to friction of legs 948 as they slide within slots 944. The friction is large enough to support the weight of the coin, but not so large as to prevent an ordinary user from sliding to adjust how deeply the prongs are received within the slots.

The sliding is now described in more detail. In some embodiments, at least one of slots 944 includes a channel 974 that runs along the length of the slot. In addition, at least one of legs 948 includes a ridge 972 that is configured to fit matingly in, and slide along channel 974, while leg 948 is being inserted in slot 944. In the embodiment of FIG. 9F, each slot has two channels, and each leg has two ridges on opposite sides that matingly in and slide along the channels, while leg 948 is being inserted in slot 944.

Moreover it is a fact of life that many coins are provided in given diameters. In some embodiments, adjusting for certain diameters can be made exactly. This can be accomplished in a number of ways. In some embodiments, a combination is provided of one or more small openings, along with one or more small bumps intended to fit into the one or more openings.

This way the leg can be prevented at least in part from sliding within the slot. It could be that the bump and opening combination provides the entire friction, or only part of it. As seen in FIG. 9F, it could be that one or more of slots 944 include one or more small openings 984. In addition, each of one or more of legs 948 includes a small bump 982 that is configured to fit into the one of openings 984. Equivalently, it could be that one of the legs includes the one or more openings, and one of the slots includes the bump, Moreover the combination of bumps and openings can be at locations such that prongs 950 will fit exactly coins of specific usual diameters. For example, a holster according to embodiments could have a combination of bumps and openings to specially accommodate diameters at 1.25″, 1.50″, 1.75″& 1.85″. Of course, the highest and lowest of these values define a range, and any diameter coin within the range may also be accommodated. In addition, a larger holster will accommodate coins of a larger diameter, and so on.

Methods are now described in more detail. In these methods, each operation can be performed as an affirmative step of doing, or causing to happen, what is written that can take place. In addition, the order of operations is not constrained to what is shown, and different orders may be possible according to different embodiments. Moreover, in certain embodiments, new operations may be added, or individual operations may be modified or deleted.

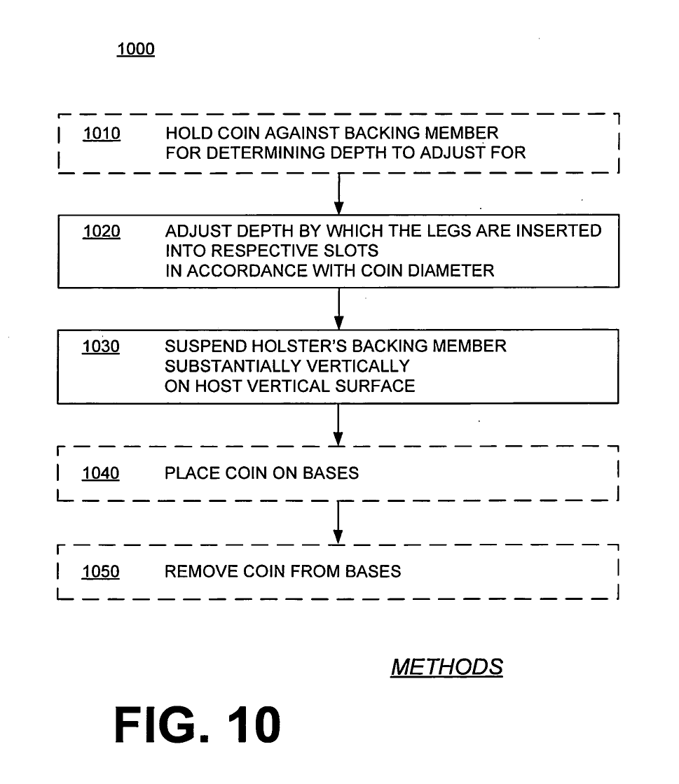

FIG. 10 shows a flowchart 1000 for describing methods according to embodiments. The methods of flowchart 1000 are for displaying an individual round coin using a holster or holder such as in the embodiments described above.

According to an optional operation 1010, the coin is held against the backing member, for determining the depth to adjust for. This will be the depth by which the legs are inserted in the slots.

According to another operation 1020, the depth by which the legs are inserted into the respective slots is adjusted. Adjusting is performed by pushing against friction. Adjusting can be in accordance with a diameter of the coin, to result in a depth where the bases contact the perimeter of the coin. For example, if the holster has two prongs and each prong has two bases, adjusting is such that all four bases contact the coin. Regardless, this adjusting is performed more easily of operation 1010 has also been performed.

According to another, optional operation 1030, the holster's backing member is suspended substantially vertically on a host vertical surface. Suspending is performed via attaching means. Attaching can be as described above. In some embodiments, the coin is held against the backing member during the suspending, in which case suspending results in the coin being supported on the bases.

In other embodiments, according to one more optional operation 1040, the coin is placed on the bases after the suspending. In other words, the backing member is suspended by itself on the surface, and then the coin is placed on the bases afterwards.

According to another, optional, and much later operation 1050, the coin is later removed from the bases, such as by pushing upwards. Operation 1050 can be performed if the plans for displaying the coin have changed.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment, extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

What is claimed is:

1. A holster for supporting a round coin on a host vertical surface, the holster comprising:
a backing member configured to be suspended substantially vertically on the host vertical surface via attaching means, the backing member having at least two slots; and
at least two prongs, each prong having a leg configured to be inserted by an adjustable depth into a respective one of the slots, each prong further having at least one base attached to the leg and configured to partially support the coin when the backing member is suspended on the host vertical surface, and the at least two prongs are inserted at least partially in the two respective slots.

2. The holster of claim 1, in which
the backing member has a substantially round shape.

3. The holster of claim 1, in which
the attaching means includes adhesive tape,

4. The holster of claim 1, in which
the attaching means includes two-sided adhesive tape.

5. The holster of claim 1, in which
the attaching means includes a magnet.

6. The holster of claim 1, in which
the attaching means includes one or more pins or needles.

7. The holster of claim 1, in which
the attaching means includes a protrusion, and
the backing member includes an opening for receiving the protrusion.

8. The holster of claim 1, in which
at least one of the prongs further includes a containing lip attached to the base.

9. The holster of claim 1, in which
at least one of the prongs has two bases.

10. The holster of claim 1, in which
at least one of the slots includes a channel, and
at least one of the legs includes a ridge configured to fit matingly in, and slide within the channel while the leg is being inserted in the slot.

11. The holster of claim 1, in which
at least one of the legs includes one or more openings, and
at least one of the slots includes a bump configured to fit into the one or more openings, for preventing at least in part the leg from sliding within the slot.

12. The holster of claim 1 in which
at least one of the slots includes one or more openings, and
at least one of the legs includes a bump configured to fit into the one or more openings, for preventing at least in part the leg from sibling within the slot.

13. A method for displaying a round coin using a holster, the holster including a backing member that has a plurality of slots and at least two prongs, each prong having a leg configured to be inserted into one of the slots, each prong further having a base, the method comprising:
adjusting a depth by which the legs are inserted into the respective slots in accordance with a diameter of the coin; and
suspending the holster's backing member substantially vertically on a host vertical surface via attaching means,
in which the coin is supported on the bases.

14. The method of claim 13, in which
the coin is held against the backing member during the suspending.

15. The method of claim 13, further comprising:
placing the coin on the bases.

16. The method of claim 13, in which
the holster has two prongs, each prong has two bases, and adjusting is such that ah four bases contact the coin.

17. The method of claim 13, further comprising;
holding the coin against the backing member for determining the depth to adjust for.

18. The method of claim 13, further comprising:
removing the coin from the bases.
